(19) United States
(12) Patent Application Publication
(10) Pub. No.: US 2018/0272330 A1
(43) Pub. Date: Sep. 27, 2018

(54) CONTAINER FOR SPECIMEN

(71) Applicants: Hyun Ku LEE, Yongin (KR); Ki Seung KIM, Seoul (KR); Ki Woung LEE, Seoul (KR)

(72) Inventors: Hyun Ku LEE, Yongin (KR); Ki Seung KIM, Seoul (KR); Ki Woung LEE, Seoul (KR)

(21) Appl. No.: 15/762,091

(22) PCT Filed: Jun. 20, 2017
(86) PCT No.: PCT/KR2017/006448

§ 371 Date: Mar. 21, 2018

(30) Foreign Application Priority Data
Jun. 22, 2016 (KR) 10-2016-0077969

(51) Int. Cl. B01L 3/00

(52) U.S. Cl. CPC B01L 3/00; B01L 2300/041; B01L 2300/0832

(57) ABSTRACT

A container for a specimen is disclosed. According to the present invention, in the container for a specimen, a specimen is stored in a first container, and a fixative is sealed and stored by a second container and a barrier film. In addition, a fixative of the second container flows into the first container in a state in which the first container and the second container are coupled to each other by means of a connection member, and thus the fixative does not leak to the outside when the fixative flows into the first container in which the specimen has been placed. Therefore, fixative leakage is relatively inhibited compared with that of a conventional specimen container in which a fixative leaks to the outside, when a specimen is put into a container main body or taken out from the container main body, and thus the present invention can have effects of enabling damage to a worker's health to be prevented as much as possible and environmental pollution to be prevented as much as possible.

### TECHNICAL FIELD

The present invention relates to a container for a specimen, capable of inhibiting leakage of a fixative for fixing a sampled specimen such that the sampled specimen is maintained in a sampled state.

### BACKGROUND ART

In the medical field, a specimen such as tissue is sampled from an examinee to perform examinations, analyses, or tests, and the sampled specimen is accommodated in a container so as to be stored and transported.

In general, a fixative for fixing a specimen in a sampled state is stored in the container for accommodating and storing the specimen, and formalin, which is an aqueous solution containing approximately 37% of formaldehyde (HCHO), is generally used as the fixative.

The formalin has functions of protein coagulation and protein polymerization, and the formalin penetrates into the tissue of the specimen, fixes the tissue of the specimen to prevent the tissue of the specimen from decomposing, and preserves the specimen in the sampled state.

The formalin has a strong stink smell. In addition, central nervous system disorders, shock, or a coma may be caused when a large amount of formalin is inhaled, and cardiac asthenia and death may be caused when a person takes a large amount of formalin. In other words, the formalin is known to be toxic, and especially carcinogenic.

Therefore, when the specimen is put into the container for the specimen, or the specimen is taken out from the container for the specimen, it is necessary to inhibit the formalin stored in the container for the specimen from leaking out of the container.

Hereinafter, a conventional specimen container disclosed in Korean Patent Application Publication No. 10-2013-0021563 (Mar. 6, 2013) will be described.

A conventional specimen container 1 includes a container main body 10 having an open upper side defined as an inlet 11 to store formalin, and a lid 20 screw-coupled to the open upper side of the container main body 10.

Then, a specimen is stored inside the container main body 10 by opening a cap portion 50 of the lid 20, putting the specimen into the container main body 10, and closing the cap portion 50. Thereafter, when the specimen needs to be taken out, the cap portion 50 is opened, and the specimen is picked up with a pincette or the like so as to be taken out from the container main body 10.

In the conventional specimen container 1 as described above, the inlet 11 of the container main body 10 is opened by the cap portion 50 when the specimen is put into the container main body 10 and the specimen is taken out from the container main body 10, evaporated formalin leaks out of the container main body 10. Therefore, a worker may inhale an evaporated formalin gas, which may damage health of the worker, and the environment may be polluted.

### DISCLOSURE

### Technical Problem

An object of the present invention is to provide a container for a specimen, capable of solving all the above-described problems of the related art.

Another object of the present invention is to provide a container for a specimen, capable of inhibiting leakage of formalin, so that health of a worker may be prevented from being damaged as possible, and the environment may be prevented from being polluted as possible.

### Technical Solution

According to the present invention, a container for a specimen may include: a first container, one side of which is open to accommodate a sampled specimen; a second container, one side of which is open to store a fixative for fixing the specimen such that the specimen is maintained in a sampled state; a barrier film for sealing the one open side of the second container; and a connection member into which the one side of the first container and the one side of the second container are detachably inserted, and when the second container is inserted into the connection member by a predetermined degree or more, the barrier film is cut off to allow the first container to communicate with the second container such that the fixative of the second container is introduced into the first container.

### Advantageous Effects

According to the present invention, in a container for a specimen, the specimen is stored in a first container, and a fixative is sealed and stored by a second container and a barrier film. In addition, the fixative of the second container is introduced into the first container in a state in which the first container and the second container are coupled to each other by means of a connection member, so that the fixative is prevented from leaking to an outside when the fixative is introduced into the first container in which the specimen has been introduced. Therefore, leakage of the fixative is relatively inhibited in comparison with that of a conventional specimen container in which a fixative leaks to an outside when a specimen is put into a container main body or taken out from the container main body. Accordingly, the present invention has effects of preventing health of a worker from being damaged as possible, and preventing the environment from being polluted as possible.

### DESCRIPTION OF DRAWINGS

FIG. 1 is a perspective view showing a container for a specimen according to one embodiment of the present invention.

FIG. 2 is an exploded sectional perspective view of FIG. 1.

FIG. 3 is an assembled perspective view of FIG. 2.

FIGS. 4A to 4C are sectional views showing a method of using the container for the specimen according to one embodiment of the present invention.

FIG. 5 is a partially exploded perspective view showing a container for a specimen according to another embodiment of the present invention.

FIG. 6A is a partially exploded perspective view showing a container for a specimen according to still another embodiment of the present invention.

FIG. 6B is a plan sectional view showing a main part of FIG. 6A.

### BEST MODE

### Mode for Invention

In the present specification, when reference numerals are given to elements of the drawings, it is to be noted that the same reference numerals are used to designate the same or similar elements even when they are shown in different drawings.

Meanwhile, the meaning of terms described herein shall be understood as follows.

Expressions in a singular form are to be construed to include the meaning of a plural form unless the context clearly indicates otherwise. Terms such as ‘first’, ‘second’, etc., may be used to distinguish one element from another element, but the scope of the present invention shall not to be construed as being limited to the terms.

Terms such as ‘including’ or ‘having’ shall not be construed to preclude any possibility of presence or addition of one or more other features, numbers, steps, operations, elements, parts, or combinations thereof.

The term ‘at least one’ is to be construed to include any combinations that can be presented from one or more associated items. For example, the expression ‘at least one of a first item, a second item, and a third item’ designates any combination of items that can be presented from two or more of the first item, the second item, and the third item, as well as the first item, the second item, or the third item.

The term ‘and/or’ is to be construed to include any combinations that can be presented from one or more associated items. For example, the expression ‘a first item, a second item, and/or a third item’ designates any combination of items that can be presented from two or more of the first item, the second item, and the third item, as well as the first item, the second item, or the third item.

When an element is referred to as being ‘connected or installed’ to another element, it is to be understood that the element may be directly connected or installed to another element, or intervening elements may be present. However, when an element is referred to as being ‘directly connected or installed’ to another element, it is to be understood that intervening elements may not be present. Meanwhile, other expressions that describe relationships between elements, such as ‘between’ and ‘directly between’, or ‘neighboring to’ and ‘directly neighboring to’, shall be construed similarly to the above description.

Hereinafter, a container for a specimen according to an embodiment of the present invention will be described in detail with reference to the accompanying drawings.

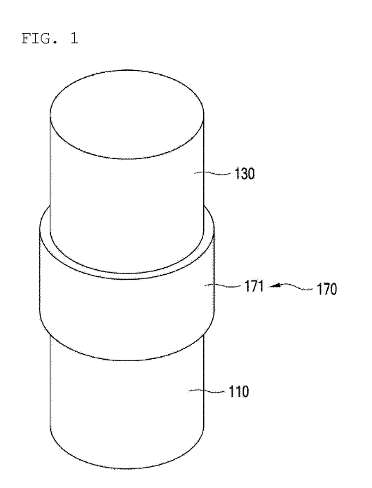

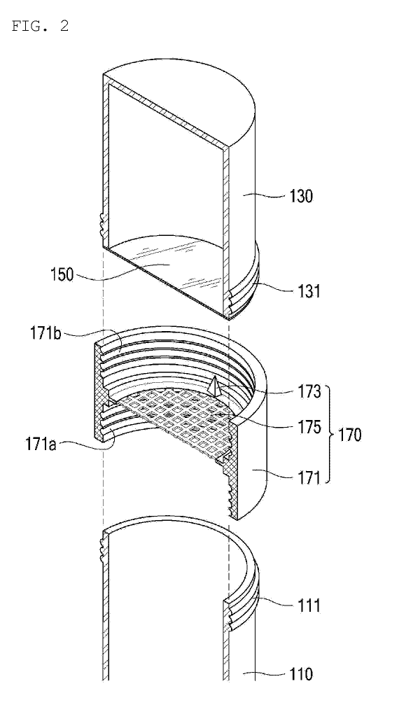

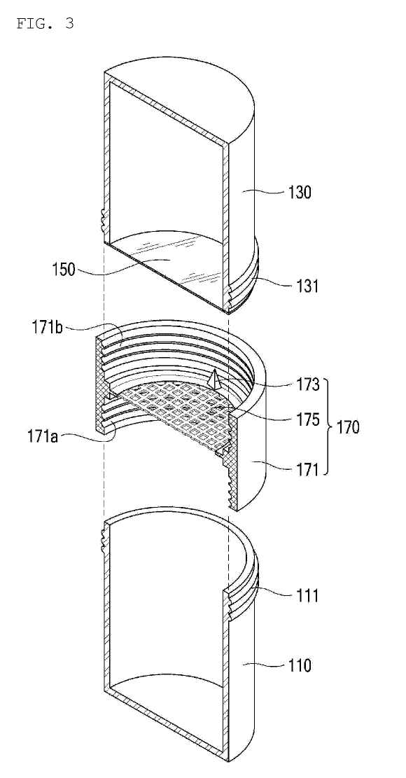

FIG. 1 is a perspective view showing a container for a specimen according to one embodiment of the present invention, FIG. 2 is an exploded sectional perspective view of FIG. 1, and FIG. 3 is an assembled perspective view of FIG. 2. As shown in the drawings, according to the embodiment of the present invention, the container for the specimen may include a first container 110, a second container 130, a barrier film 150, and a connection member 170.

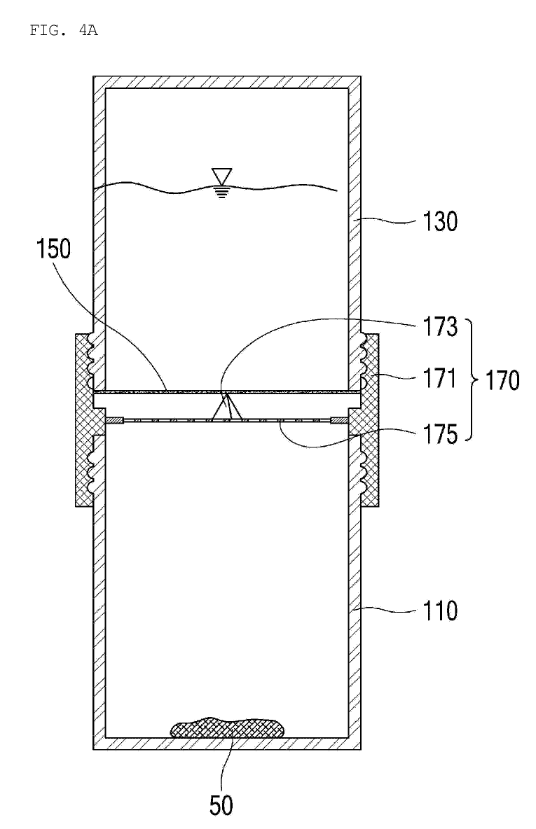

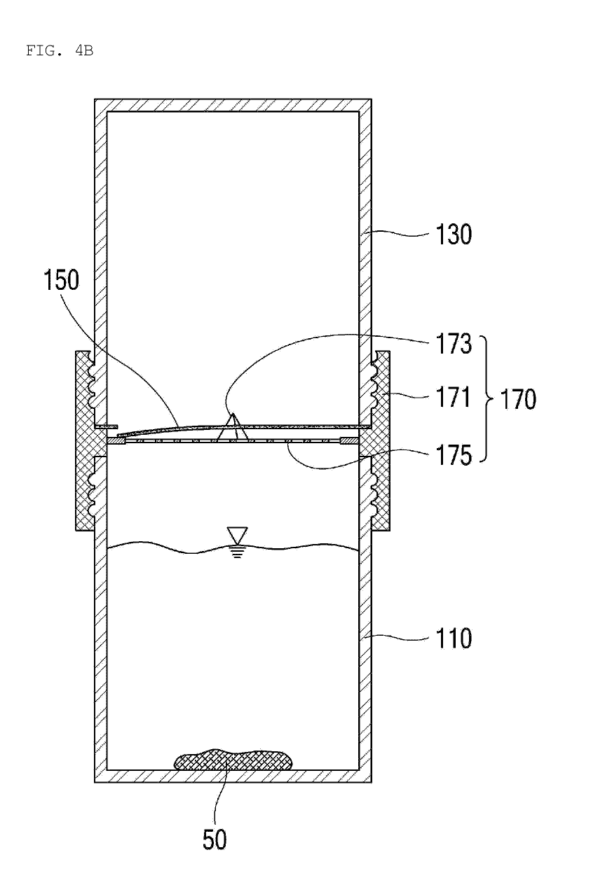

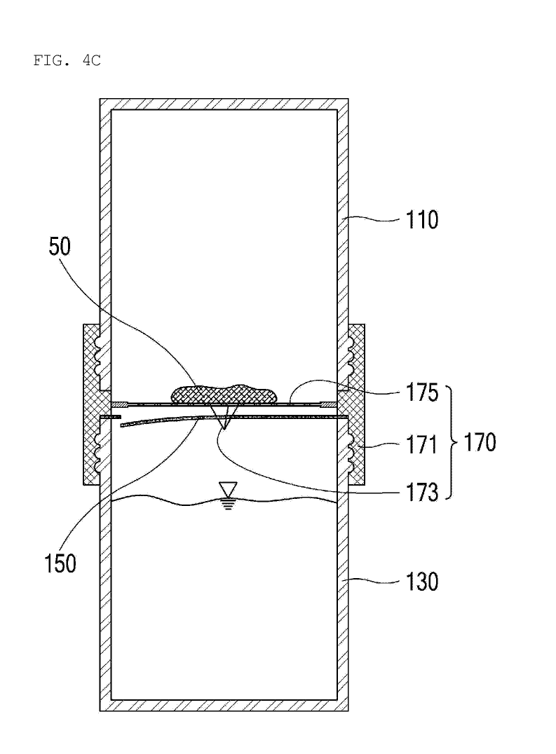

The first container 110 may be formed in a cylindrical shape, one side of which is open, and may accommodate a specimen 50 when the specimen 50 (see FIG. 4A) sampled from an examinee is put into the one open side of the first container 110.

The second container 130 may be foiled in a cylindrical shape, one side of which is open, and a fixative such as formalin may be stored in the second container 130. The fixative penetrates into tissue of the specimen 50 to prevent the tissue from decomposing, so that the specimen 50 may be fixed and preserved in a sampled state.

Since the fixative may be toxic, it is necessary to prevent the fixative stored in the second container 130 from leaking out of the second container 130.

In order to prevent the fixative from leaking through the one open side of the second container 130, the barrier film 150 may be formed on the one open side of the second container 130, and the barrier film 150 may be formed of aluminum foil or plastic. The barrier film 150 may be formed on the one open side of the second container 130 by thermal fusion or the like.

The connection member 170 may connect the first container 110 to the second container 130 while allow the first container 110 to communicate with the second container 130.

In detail, an outer peripheral surface of the one side of the first container 110 may be detachably inserted into an inner peripheral surface of one side of the connection member 170, and an outer peripheral surface of the one side of the second container 130 may be detachably inserted into an inner peripheral surface of an opposite side of the connection member 170. In order to detachably insert the first container 110 and the second container 130 into the connection member 170, screw threads 171a and 111 may be formed at the inner peripheral surface of the one side of the connection member 170 and the outer peripheral surface of the one side of the first container 110, respectively, so as to be engaged with each other, and screw threads 171b and 131 may be formed at the inner peripheral surface of the opposite side of the connection member 170 and the outer peripheral surface of the one side of the second container 130, respectively, so as to be engaged with each other. Accordingly, the connection member 170 and the first container 110 may be coupled to or separated from each other as the connection member 170 is rotated in the forward and reverse directions or the first container 110 is rotated in the forward and reverse directions, and the connection member 170 and the second container 130 may be coupled to or separated from each other as the connection member 170 is rotated in the forward and reverse directions or the second container 130 is rotated in the forward and reverse directions.

At this time, if the outer peripheral surface of the one side of the second container 130 is inserted into the inner peripheral surface of the opposite side of the connection member 170 by a predetermined depth or more, the barrier film 150 may be cut off by a cutting protrusion 173, which will be described below. Then, since the second container 130 and the first container 110 communicate with each other, the fixative of the second container 130 may be introduced into the first container 110. When the fixative is introduced into the first container 110, the specimen 50 accommodated in the first container 110 may be fixed.

Hereinafter, the connection member 170 will be described in detail.

The connection member 170 may include a coupling frame 171, a cutting protrusion 173, and a filter net 175.

The coupling frame 171 may be formed in a ring shape, and may have the above-described screw threads 171a and 171b, which are formed at one side of an inner peripheral surface of the coupling frame 171 and an opposite side of the inner peripheral surface of the coupling frame 171, respectively, so that the outer peripheral surface of the one side of the first container 110 and the outer peripheral surface of the one side of the second container 130 may be detachably inserted into the coupling frame 171.

In addition, the cutting protrusion 173 may be formed in a conical shape and disposed at the inner peripheral surface of the coupling frame 171, and may cut the barrier film 150 when the outer peripheral surface of the one side of the second container 130 is inserted into the opposite side of the inner peripheral surface of the coupling frame 171 by a predetermined depth or more. A plurality of cutting protrusions 173 may be arranged in a circumferential direction while being spaced apart from each other at predetermined intervals.

When the barrier film 150 is cut off by the cutting protrusion 173 (see FIG. 3), a liquid stored in the second container 130 is introduced into the first container 110 to fix the specimen 50. In this state, in order to take out the specimen 50 accommodated in the first container 110 from the first container 110, the first container 110 is turned over so as to be positioned above the second container 130. Then, the fixative of the first container 110 is introduced back into the second container 130.

When the fixative of the first container 110 is reintroduced into the second container 130, if the specimen 50 of the first container 110 is prevented from being introduced into the second container 130, it is convenient to take out the specimen 50.

The filter net 175 may be formed on the inner peripheral surface of the coupling frame 171 to prevent the specimen 50 of the first container 110 from being introduced into the second container 130 when the fixative introduced into the first container 110 is reintroduced into the second container 130. Then, the specimen 50 mounted on the filter net 175 may be taken out with a pincette or the like, which is very convenient.

When the second container 130 is coupled to the connection member 170, if the cutting protrusion 173 is positioned closer to the second container 130 than the filter net 175, the cutting protrusion 173 may cut the barrier film 150 without being interfered by the filter net 175.

Hereinafter, a method of using the container for the specimen according to an embodiment of the present invention will be described with reference to FIGS. 4A to 4C. FIGS. 4A to 4C are sectional views showing the method of using the container for the specimen according to one embodiment of the present invention.

First, the specimen 50 sampled from the examinee is put into and stored in the first container 110 through the one open side of the first container 110, and the one side of the inner peripheral surface of the connection member 170 is coupled to the one open side of the first container 110. Thereafter, the one side of the second container 130 having the barrier film 150 is coupled to the opposite side of the inner peripheral surface of the connection member 170. At this time, the one side of the second container 130 is coupled to the opposite side of the inner peripheral surface of the connection member 170 by a depth which is enough to prevent the barrier film 150 from being cut off by the cutting protrusion 173 of the connection member 170. In addition, the second container 130 is positioned above the first container 110. Then, a state shown in FIG. 4A is obtained.

In the state shown in FIG. 4A, when the second container 130 or the connection member 170 is rotated such that the one side of the second container 130 is further inserted into the connection member 170, the barrier film 150 is cut off by the cutting protrusion 173 as shown in FIG. 4B. Accordingly, the fixative of the second container 130 may be introduced into the first container 110, and the specimen 50 of the first container 110 may be maintained in a sampled state by the fixative.

The specimen 50 is transferred in a state shown in FIG. 4B.

Thereafter, as shown in FIG. 4C, when the first container 110 is turned over so as to be positioned above the second container 130, the fixative of the first container 110 is reintroduced into the second container 130, and the specimen 50 of the first container 110 is caught and supported by the filter net 175 of the connection member 170.

In a state shown in FIG. 4C, the first container 110 is separated from the connection member 170, and the specimen 50 is taken out.

In the container for the specimen according to the embodiment of the present invention, the specimen 50 is stored in the first container 110, and the fixative is sealed and stored by the second container 130 and the barrier film 150. In addition, the fixative of the second container 130 is introduced into the first container 110 in a state in which the first container 110 and the second container 130 are coupled to each other by means of the connection member 170, so that the fixative is prevented from leaking to an outside when the fixative is introduced into the first container 110 in which the specimen 50 has been introduced. Therefore, the leakage of the fixative is relatively inhibited in comparison with that of the conventional specimen container 1 in which the fixative leaks to the outside when the specimen is put into or taken out from the conventional specimen container 1.

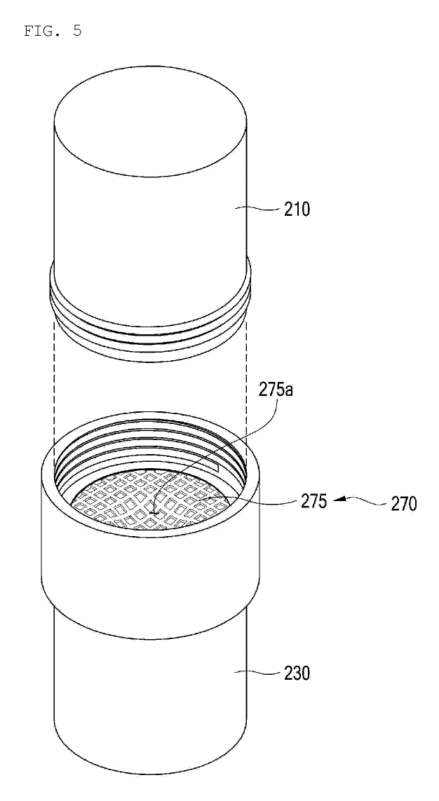

FIG. 5 is a partially exploded perspective view showing a container for a specimen according to another embodiment of the present invention, and the following description will be focused on differences from FIG. 2.

As shown in the drawings, a center portion of a filter net 275 of a connection member 270 may be recessed (275a) toward a second container 230. Then, when a first container 210 is turned over so as to be positioned above the second container 230 in order to take out the specimen 50 (see FIG. 4A), the specimen 50 of the first container 210 is positioned at a recessed portion 275a of the filter net 275. Accordingly, the specimen 50 can be taken out more conveniently.

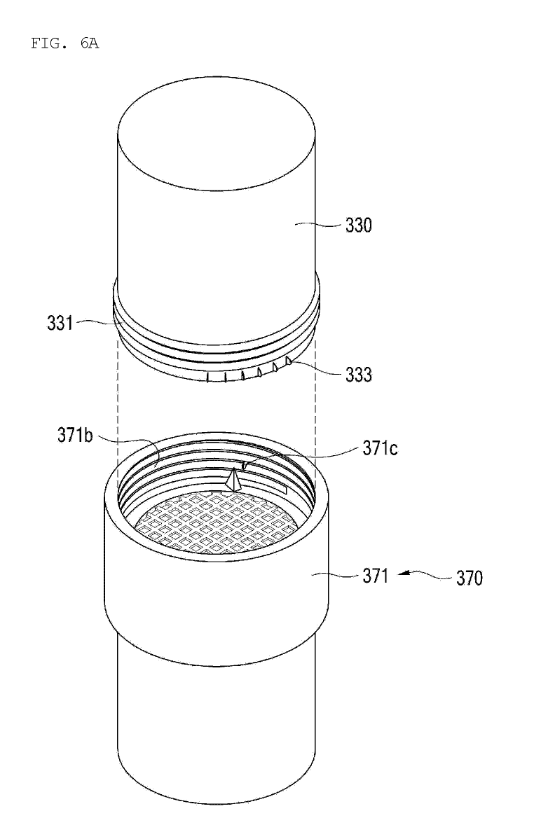

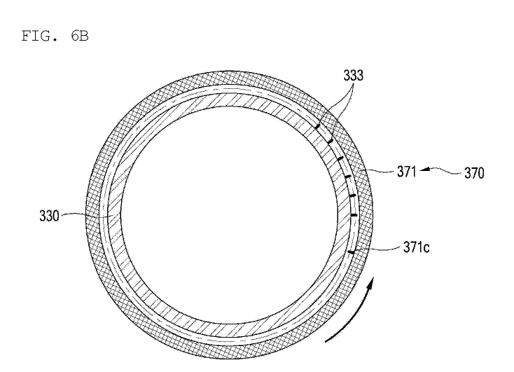

FIG. 6A is a partially exploded perspective view showing a container for a specimen according to still another embodiment of the present invention, FIG. 6B is a plan sectional view showing a main part of FIG. 6A, and the following description will be focused on differences from FIG. 2.

As shown in the drawings, an indication protrusion 371c may be formed at an inner peripheral surface of a coupling frame 371 of a connection member 370 and an indication protrusion 333 may be formed at an outer peripheral surface of one side of a second container 330, in which the indication protrusions 371c and 333 are matched with each other to indicate coupling positions of the coupling frame 371 and the second container 330.

In more detail, the indication protrusions 371c and 333 may inform that the barrier film 150 is cut off by a cutting protrusion 373. In other words, when the outer peripheral surface of the one side of the second container 330 is rotated and inserted into an opposite side of the inner peripheral surface of the coupling frame 371, if the coupling frame 371 or the second container 330 is further rotated after the indication protrusion 371c of the coupling frame 371 initially matches the indication protrusion 333 of the second container 330, it is informed that the barrier film 150 is cut off by the cutting protrusion 373.

The indication protrusion 371c of the coupling frame 371 is preferably formed at a portion where the screw thread 371b is formed, and the indication protrusion 333 of the second container 330 is preferably formed at a lower portion of the screw thread 331. In addition, in order to inform a state in which the barrier film 150 is being cut off by the cutting protrusion 373, at least one of the indication protrusion 371c of the coupling frame 371 and the indication protrusion 333 of the second container 330 may be prepared as plural.

It will be apparent to those skilled in the art that the present invention described above is not limited to the above-described embodiments and the accompanying drawings, and various substitutions, modifications, and changes can be made without departing from the spirit and scope of the present invention. Therefore, the scope of the present invention is defined by the appended claims, and all changes or modifications derived from the meaning and scope of the claims and their equivalents should be construed as being included in the scope of the present invention.

1-6. (canceled)

7. A container for a specimen, the container comprising:
a first container, one side of which is open to accommodate a sampled specimen, in which a screw thread is formed at an outer peripheral surface of the one side that is open;
a second container, one side of which is open, in which a screw thread is formed at an outer peripheral surface of the one side that is open; a barrier film for sealing the one open side of the second container; and a connection member formed at an inner peripheral surface thereof with a screw thread, including a coupling frame having one side screw-coupled with the first container and having an opposite side screw-coupled with the second container, and including a cutting protrusion formed at the coupling frame to cut the barrier film,
wherein the second container stores a fixative for fixing the specimen such that the specimen is maintained in a sampled state, and when the second container is inserted into the connection member by a predetermined degree or more, the barrier film is cut off to allow the first container to communicate with the second container such that the fixative of the second container is introduced into the first container.

8. The container of claim 1, wherein the barrier film is formed of aluminum foil or plastic.

9. The container of claim 1, wherein the connection member further comprises a filter net supported by the coupling frame to prevent the specimen of the first container from being introduced into the second container.

10. The container of claim 9, wherein a center portion of the filter net is recessed toward the second container.

11. The container of claim 9, wherein an indication protrusion is formed at an inner peripheral surface of the coupling frame and another indication protrusion is formed at an outer peripheral surface of the one side of the second container, in which the indication protrusions are matched with each other to indicate coupling positions of the coupling frame and the second container.
